(19) United States
(12) Patent Application Publication
(10) Pub. No.: US 2022/0227988 A1
(43) Pub. Date: Jul. 21, 2022

(54) THERMOPLASTIC ELASTOMER GEL

(71) Applicant: Avient Corporation, Avon Lake, OH (US)

(72) Inventors: Christopher ENGEL, Cary, IL (US); Liang XU, Vernon Hills, IL (US)

(73) Assignee: Avient Corporation, Avon Lake, OH (US)

(21) Appl. No.: 17/606,355

(22) PCT Filed: Apr. 24, 2020
(86) PCT No.: PCT/US2020/029713

§ 371 Date: Oct. 25, 2021

Related U.S. Application Data
(60) Provisional application No. 62/839,434, filed on Apr. 26, 2019.

(51) Int. Cl. C08L 53/02

(52) U.S. Cl. CPC C08L 53/02; C08L 2205/025

(57) ABSTRACT

A thermoplastic elastomer (TPE) compound is disclosed which has very low hardness by virtue of the use of a combination of high styrene content styrene-ethylene-ethylene-propylene-styrene copolymer, a conventional styrene-ethylene-ethylene-propylene-styrene copolymer, and a plasticizer. Super-soft extruded or molded plastic articles may be formed from pellets of the compound, with a resulting Shore OO Hardness of between about 35 to about 52. Molded articles may be prepared using injection molding techniques.

### CLAIM OF PRIORITY

This application claims the benefit of U.S. Provisional Patent Application Ser. No. 62/839,434 bearing Attorney Docket Number 12019011 and filed on Apr. 26, 2019, which is hereby incorporated by reference in its entirety.

### FIELD OF THE INVENTION

This invention relates to thermoplastic elastomers, specifically, gelatinous elastomer materials.

### BACKGROUND OF THE INVENTION

Thermoplastic elastomeric gels based on styrenic block copolymers and oil are well known and are used in a variety of applications, including but not limited to, vibration damping, pressure relief, cushioning, grips, therapeutic and orthopedic devices, among others, What exists, however, is a need for an improved thermoplastic elastomeric gel compound that has good viscosity, hardness and compression set physical Characteristics.

### SUMMARY OF THE INVENTION

The present technology relates to a thermoplastic elastomeric gel compound.

The thermoplastic elastomer gel compound of the present technology may include a high styrene content styrene-ethylene-ethylene-propylene-styrene copolymer, a conventional styrene-ethylene-ethylene-propylene-styrene copolymer; and a plasticizer. In an embodiment, the compound may include optional additives.

In an aspect, the present technology may disclose a method of injection molding a thermoplastic gel compound into a desired shape.

The thermoplastic elastomer gel compound of the present technology may have good viscosity, hardness and compression set physical characteristics.

Features of the invention will become apparent with reference to the following embodiments.

### EMBODIMENTS OF THE INVENTION

In some embodiments, the invention is directed to thermoplastic compounds.

In other embodiments, the invention is directed to thermoplastic articles.

In further embodiments, the invention is directed to methods of making thermoplastic articles.

Required and optional features of these and other embodiments of the disclosed invention are described.

As used herein, the term “compound” means a composition or mixture resulting from melt mixing, or compounding, a neat polymer resin and at least one other ingredient including but not limited to one or more additives, or one or more other polymer resins, or both.

As used herein, the term “formed from” (including related terms such as “forming”) means, with respect to an article (or component of an article) and a thermoplastic material, that the article (or component of the article) is extruded, molded, shaped, pressed, or otherwise made from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the term “free of” a certain component or substance means, in some embodiments, that no amount of that component or substance is intentionally present, and, in other embodiments, that no functionally effective amount of that component or substance is present, and, in further embodiments, that no amount of that component or substance is present.

As used herein, the term “Hardness” means the hardness of a specimen as determined according to ASTM D2240. Hardness is reported as Shore OO hardness unless specifically identified otherwise.

The present technology provides a thermoplastic elastomer gel suitable for use in consumer applications requiring soft gel articles, e.g., cushions. The thermoplastic elastomer gel (“gel compound”) may include a styrenic block polymer, a plasticizer, and optional additives. Each of such ingredients may comprise a single component or several different components. For example, in an embodiment, the styrenic block polymer may include at least two different styrenic block copolymers, e.g., a high styrene content styrene-ethylene-ethylene-propylene-styrene polymer and a conventional styrene-ethylene-ethylene-propylene-styrene polymer. The gel compound may not include all of the above components. The gel compound may include additional components beyond those discussed above.

The gel compound has many benefits, including, but not limited to, improved softness, improved elasticity, and improved processability when compared to currently commercially available gel compounds.

Styrenic Block Copolymers

The gel compound may include a styrenic block copolymer (“SBC”). One such particular SBC that may be used in this technology is styrene-ethylene-ethylene-propylene-styrene (SEEPS) polymer. SEEPS polymers are hydrogenated di-block and tri-block styrene copolymers capable of exhibiting rubber-like properties over a broad range of temperature. SEEPS polymer exhibit many physical properties that are useful in the present technology, including, but not limited to, improved tensile strength and resistance to environmental factors. SEEPS polymers are thermoplastic elastomers that may be recycled. In the presence of heat and shear during processing, the polystyrene domains soften and permit flow.

There are various types of SEEPS polymers that provide different benefits to an end composition. For example, the present gel compound may include a hydrogenated SEEPS copolymer with a high styrene content (e.g., a styrene content>35% by weight, (“high styrene content SEEPS copolymer”). A high styrene content SEEPS copolymer may have a large molecular weight, e.g., approximately a weight average molecular weight between 250,000 to 350,000, which in turn, provides a molecular weight for the gel compound. A large molecular weight would allow for a good compression set of the end gel compound, and allow for improved flow, lower viscosity and quick setup in a melt. A non-limiting example of a high styrene content SEEPS copolymer that may be used in the present technology is Septon™ J3341. As discussed in U.S. Pat. No. 9,831,655, the Septon™ J3341 copolymer is an exemplary star copolymer, meaning that it has several linear chains connected to a central core such that its compact structure, high arm density and large molecular weight provide a good compression set for the end product among other desirable features. In an embodiment, the gel compound may include one or more high styrene content SEEPS copolymer. In an embodiment, the gel compound may include one or more conventional styrene content SEEPS copolymer.

The present gel compound may also include a conventional hydrogenated SEEPS triblock copolymer, i.e., a SEEPS triblock copolymer with a styrene content of less than 35% (“conventional SEEPS copolymer”). In an embodiment, the weight average molecular weight for a conventional SEEPS copolymer is between 100,000 to 350,000. The conventional SEEPS copolymer may have a lower molecular weight than the high styrene content SEEPS copolymer. Examples of such conventional SEEPS polymers include, but are not limited to, Septon™ 4000 series, e.g., Septon™ 4055, Septon™ 4044, and Septon™ 4033. In an embodiment, the gel compound may include conventional SEEPS copolymer. In an embodiment, the gel compound may include more than one conventional SEEPS copolymer. In an embodiment, the conventional SEEPS copolymer may have a medium molecular weight, e.g., Septon™ 4044.

In an aspect, the high molecular weight conventional SEEPS copolymer may have a weight average molecular weight between 250,000 to 350,000. In an aspect, a medium molecular weight conventional SEEPS copolymer may have a weight average molecular weight between about 150,000 and about 250,000. In an aspect, a low molecular weight conventional SEEPS copolymer has weight average between 50,000 to 150000. In an aspect, Septon™ 4055 is an exemplary high molecular weight SEEPS copolymer. In an aspect, Septon™ 4044 is an exemplary medium molecular weight SEEPS copolymer. In an aspect, Septon™ 4033 is an exemplary low molecular weight SEEPS copolymer.

High styrene content SEEPS copolymer, e.g., Septon™ J3341 may provide a characteristic low compression set and softness. However, because the molecular weight and styrene content is high, even though the overall viscosity is low, the molecule sets up very fast in a molding process especially conventional molding process, which may lead to processing difficulties and aesthetics issue of final molded parts. Conventional SEEPS copolymers may not provide the desired balance of good compression set and good flow properties for a gel, either a low compression set with high viscosity or a high compression set with low viscosity. Adding a conventional SEEPS copolymer to a high styrene content SEEPS copolymer compound may modify that compound. In doing so, one achieves unexpected results that the resulting compound it exhibits a good balance of all desired properties, i.e., low compression set with low viscosity.

The amount of SEEPS copolymer (both high styrene and conventional) may be provided in any appropriate ratio, including, but not limited to, 90:10 high styrene content SEEPS copolymer:conventional SEEPS copolymer; 80:20 high styrene content SEEPS copolymer:conventional SEEPS copolymer; 70:30 high styrene content SEEPS copolymer:conventional SEEPS copolymer; 60:40 high styrene content SEEPS copolymer:conventional SEEPS copolymer; or even 50:50 high styrene content SEEPS copolymer:conventional SEEPS copolymer.

The amount of SEEPS copolymer (i.e., the total of both high styrene and conventional) in the compound may be any appropriate amount, including but not limited to, 20-120 parts by weight of the gel compound; 40-100 parts by weight of the gel compound; and 60-80 parts by weight of the gel compound.

### Plasticizer Oil

Any conventional plasticizer, preferably a paraffinic oil, is suitable for use the present technology. The plasticizer may be used, for example, to adjust softness and/or improve flow or other properties of the thermoplastic elastomer gel compound. Any conventional oil capable of plasticizing styrenic block copolymer, such as mineral oil, vegetable oil, synthetic oil, etc., may be used in the present invention. Examples of commercially available oils include those available under the PURETOL™ 380 brand from Petro-Canada™, and those available under the PRIMOL™ 382 brand from ExxonMobil™.

In some embodiments, plasticizers with a higher molecular weight than that of the aforementioned conventional oils may be used. Polyisobutene (PIB) is an example of such a plasticizer with a relatively higher molecular weight. For example, medium- to high-molecular weight PIB is commercially available under the OPPANOL™ brand from BASF™.

The amount of plasticizer oil in the gel compound may be any appropriate amount, including but not limited to, about 100 to about 400 parts by weight of the gel compound; about 150 to about 350 parts by weight of the gel compound; and about 200 to about 300 parts by weight of the gel compound.

### Optional Additives

The compound of the present invention may include conventional plastics additives in an amount that is sufficient to obtain a desired processing or performance property for the compound. The amount should not be wasteful of the additive or detrimental to the processing or performance of the compound. Those skilled in the art of thermoplastics compounding, without undue experimentation but with reference to such treatises as Plastics Additives Database (2004) from Plastics Design Library (www.williamandrew.com), may select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppresants; impact modifiers; initiators; lubricants; micas; pigments, colorants and dyes; plasticizers; processing aids; other polymers; release agents; silanes, titanates and zirconates; slip and anti-blocking agents; stabilizers; stearates; ultraviolet light absorbers; viscosity regulators; waxes; and combinations of them.

A preferred anti-oxidant is an Irganox brand pentaerythritol antioxidant identified as CAS 6683-19-8. A preferred processing stabilizer is an Irgafos brand trisarylphosphite processing stabilizer identified as CAS No. 31570-04-4.

### Ranges of Ingredients

Table 1 shows the acceptable, desirable, and preferable ranges of ingredients for the gel compound of the present invention.

TABLE 1
Ranges of Ingredients (parts per weight)

| Ingredient | Acceptable | Desirable | Preferable |
|---|---|---|---|
| High Styrene Content | 20-120 | 40-100 | 40-90 |
| SEEPS Polymer | | | |
| Conventional SEEPS | 10-120 | 10-90 | 10-60 |
| Polymer | | | |
| Plasticizer Oil | 100-400 | 150-350 | 200-300 |
| Anti-oxidant | 0-20 | 0-15 | 0-7 |
| Processing Stabilizer | 0-20 | 0-15 | 0-7 |
| Other Optional | 0-30 | 0-20 | 0-10 |
| Additives | | | |

Reshaping into Plastic Article

With pellets of thermoplastic elastomer compound made via continuous extrusion processing, persons having ordinary skill in the art, without undue experimentation, may reshape the pellets into any conceivable plastic article that has a Shore OO Hardness of less than about 60.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.williamandrew.com), one may make articles of any conceivable shape and appearance using compounds of the present invention.

Typical processes used to mold such soft thermoplastic elastomer compounds include casting, rotational molding, slush molding, extrusion coating, injection molding, compression molding, transfer molding, and dip molding. Such soft thermoplastic elastomer compounds may also be over-molded or extruded onto rigid substrates. Such soft thermoplastic elastomer compounds may also be melted in a melting tank and pumped as a liquid into molds.

The low hardness thermoplastic elastomer compounds of this invention may exhibit low melt viscosity values. Alternatively, the compounds of this invention may processed via a pourable or dispensing gel process.

### Usefulness of the Invention

The gel compound of the present invention has an excellent versatility as a molded gel plastic article because of the massive presence of the plasticizer oil, which does not exude during use in temperatures between about 40° F. and 110° F.

The addition of anti-oxidant properties and thermal stabilization, by those respective functional additives allows the gel compound to have durable properties any gelatinous plastic article should have.

The formed thermoplastic elastomer may be used in the injection molding of plastic articles which benefits from highly elastic, molded soft gel compound of the present invention.

Markets or industries into which the highly elastic, molded soft gel compound may be introduced include healthcare (beds, cushions, pillows, and bandages); consumer goods (comfort grips on power hand tools, rakes, shovels, lawn mowers, shoes, boots, golf clubs, fishing poles, and watercraft); personal care products (comfort grips on toothbrushes, razors, combs, and hair brushes); transportation (comfort grips on steering wheels); and personal apparel (clothing and footwear). Of these various possibilities, gel compounds are particularly suitable for cushions in bedding, wheelchairs, and other healthcare cushion applications, shoe in-soles, toe separators, novelties and toys, non-healthcare-related cushions, and ergonomic mats of all types.

### EXAMPLES

Examples provide data for evaluation of the unpredictability of this invention.

Table 2 shows the list of ingredients in the Examples and Comparative Examples.

TABLE 2

| | | Brand | Commercial |
|---|---|---|---|
| Ingredient Name | Purpose | Name | Source |
| Polystyrene-polyethylene- | Elastomer | Septon | Kuraray Co., |
| ethylene-propylene- | | J3341 | LTD. |
| polystyrene copolymer | | | |
| Polystyrene-polyethylene- | Elastomer | Septon | Kuraray Co., |
| ethylene-propylene- | | 4055 | LTD. |
| polystyrene copolymer | | | |
| Polystyrene-polyethylene- | Elastomer | Septon | Kuraray Co., |
| ethylene-propylene- | | 4044 | LTD. |
| polystyrene copolymer | | | |
| Polystyrene-polyethylene- | Elastomer | Septon | Kuraray Co., |
| ethylene-propylene- | | 4033 | LTD. |
| polystyrene copolymer | | | |
| Mineral Oil | Plasticizer | Puretol | Petro-Canada |
| | | 10 | Lubricants, Inc. |
| Blue color | Colorant | Trans | PolyOne |
| | | Blue | |
| Tris(2,4-ditert- | Antioxident | Irgafos | BASF |
| butylphenyl)phosphite | | 168 | |
| Pentaerythritol Tetrakis(3- | Antioxidant | Irganox | BASF |
| (3,5-di-tert-butyl-4- | | 1010 | |
| hydroxyphenyl)propionate) | | | |

Table 3 shows the recipes for the Examples, Table 4 shows the method for making the Examples, and Table 5 shows the physical characteristics of the Examples.

TABLE 3

| | Example | Example | Example | Example | Example | Example |
|---|---|---|---|---|---|---|
| Ingredient | 1 | 2 | 3 | 4 | 5 | 6 |

Formulations (ppw)

| | | | | | | |
|---|---|---|---|---|---|---|
| Septon J3341 | 100 | | | | 90 | 70 |
| Septon 4055 | | 100 | | | 10 | 30 |
| Septon 4044 | | | 100 | | | |
| Septon 4033 | | | | 100 | | |
| Puretol 10 | 235 | 235 | 235 | 235 | 235 | 235 |
| Trans Blue | 0.9 | 0.9 | 0.9 | 0.9 | 0.9 | 0.9 |
| Irgafos 168 | 2.75 | 2.75 | 2.75 | 2.75 | 2.75 | 2.75 |
| Irganox 1010 | 2.75 | 2.75 | 2.75 | 2.75 | 2.75 | 2.75 |

TABLE 4

| Example | Example | Example | Example | Example | Example |
|---|---|---|---|---|---|
| 1 | 2 | 3 | 4 | 5 | 6 |

Henschel Mixing Conditions

| | | | | | | |
|---|---|---|---|---|---|---|
| Mixing | Twin | Twin | Twin | Twin | Twin | Twin |
| Equipment | Screw | Screw | Screw | Screw | Screw | Screw |
| | extruder | extruder | extruder | extruder | extruder | extruder |
| Mixing | 180 | 180 | 180 | 180 | 180 | 180 |
| Temp. (° C.) | | | | | | |
| Mixing | 500 | 500 | 500 | 500 | 500 | 500 |
| Speed (rpm) | | | | | | |
| Order of | Altogether | Altogether | Altogether | Altogether | Altogether | Altogether |
| Addition of | | | | | | |
| Ingredients | | | | | | |
| Form of Product | Pellets | Pellets | Pellets | Pellets | Pellets | Pellets |
| After Mixing | | | | | | |

TABLE 5

| Example | Example | Example | Example | Example | Example |
|---|---|---|---|---|---|
| 1 | 2 | 3 | 4 | 5 | 6 |

Properties

| | | | | | | |
|---|---|---|---|---|---|---|
| Shore OO Hardness | 32.4 | 46.8 | 52.5 | 57.5 | 34.6 | 37 |
| (ASTM D2240, 10 s delay) | | | | | | |
| Specific gravity | 0.866 | 0.862 | 0.859 | 0.863 | 0.866 | 0.865 |
| (ASTM D792) | | | | | | |
| Capillary Rheometer | 200 | 200 | 200 | 200 | 200 | 200 |
| test temperature (° C.) | | | | | | |
| Viscosity @ | 24.2 | 41.8 | 27.8 | 8.9 | 25 | 31.9 |
| 1340.5/sec (Pa · s) | | | | | | |
| Viscosity @ | 208.7 | 590.1 | 113.8 | 205.1 | 228.7 | 334.8 |
| 67/sec (Pa · s) | | | | | | |
| Compression set test | 23 | 23 | 23 | 23 | 23 | 23 |
| temperature (° C.) | | | | | | |
| Compression set (%) | 10 | 12.6 | 10 | 80.9 | 15.3 | 13.4 |
| Aesthetics of the | Poor | Poor | Poor | Poor | Good | Excellent |
| molded plaque | | | | | | |

Table 6 shows the recipes for additional Examples, Table 7 shows the method for making additional Examples, and Table 8 shows the physical characteristics of the additional Examples.

TABLE 6

| | Example | Example | Example | Example | Example | Example |
|---|---|---|---|---|---|---|
| Ingredient | 7 | 8 | 9 | 10 | 11 | 12 |

Formulations (ppw)

| | | | | | | |
|---|---|---|---|---|---|---|
| Septon J3341 | 50 | 30 | 10 | 90 | 70 | 50 |
| Septon 4055 | 50 | 70 | 90 | | | |
| Septon 4044 | | | | 10 | 30 | 50 |
| Septon 4033 | | | | | | |
| Puretol 10 | 235 | 235 | 235 | 235 | 235 | 235 |
| Trans Blue | 0.9 | 0.9 | 0.9 | 0.9 | 0.9 | 0.9 |
| Irgafos 168 | 2.75 | 2.75 | 2.75 | 2.75 | 2.75 | 2.75 |
| Irganox 1010 | 2.75 | 2.75 | 2.75 | 2.75 | 2.75 | 2.75 |

TABLE 7

| Example | Example | Example | Example | Example | Example |
|---|---|---|---|---|---|
| 7 | 8 | 9 | 10 | 11 | 12 |

Henschel Mixing Conditions

| | | | | | | |
|---|---|---|---|---|---|---|
| Mixing | Twin | Twin | Twin | Twin | Twin | Twin |
| Equipment | Screw | Screw | Screw | Screw | Screw | Screw |
| | extruder | extruder | extruder | extruder | extruder | extruder |
| Mixing | 180 | 180 | 180 | 180 | 180 | 180 |
| Temp. (° C.) | | | | | | |
| Mixing | 500 | 500 | 500 | 500 | 500 | 500 |
| Speed (rpm) | | | | | | |
| Order of | Altogether | Altogether | Altogether | Altogether | Altogether | Altogether |
| Addition of | | | | | | |
| Ingredients | | | | | | |
| Form of Product | Pellets | Pellets | Pellets | Pellets | Pellets | Pellets |
| After Mixing | | | | | | |

TABLE 8

| Example | Example | Example | Example | Example | Example |
|---|---|---|---|---|---|
| 7 | 8 | 9 | 10 | 11 | 12 |

Properties

| | | | | | | |
|---|---|---|---|---|---|---|
| Shore OO Hardness | 40.5 | 43.8 | 45.8 | 35.8 | 40.5 | 44.2 |
| (ASTM D2240, 10 s delay) | | | | | | |
| Specific gravity | 0.865 | 0.863 | 0.862 | 0.864 | 0.863 | 0.863 |
| (ASTM D792) | | | | | | |
| Capillary Rheometer | 200 | 200 | 200 | 200 | 200 | 200 |
| test temperature (° C.) | | | | | | |
| Viscosity @ | 33.3 | 37 | 40.6 | 22.9 | 25.4 | 24.4 |
| 1340.5/sec (Pa · s) | | | | | | |
| Viscosity @ | 398.5 | 571 | 594.7 | 202.7 | 175.6 | 157.7 |
| 67/sec (Pa · s) | | | | | | |
| Compression set test | 23 | 23 | 23 | 23 | 23 | 23 |
| temperature (° C.) | | | | | | |
| Compression set (%) | 12.4 | 17 | 13.6 | 11.5 | 12.6 | 7.8 |
| Aesthetics of the | Good | Poor | Poor | Good | Excellent | Good |
| molded plaque | | | | | | |

Table 9 shows the recipes for additional Examples, Table 10 shows the method for making additional Examples, and Table 11 shows the physical characteristics of the additional Examples.

TABLE 9

| Example | Example | Example | Example | Example | Example | Example |
|---|---|---|---|---|---|---|
| 13 | 14 | 15 | 16 | 17 | 18 | 19 |

Formulation (ppw)

| | | | | | | | |
|---|---|---|---|---|---|---|---|
| Septon J3341 | 30 | 10 | 90 | 70 | 50 | 30 | 10 |
| Septon 4055 | | | | | | | |
| Septon 4044 | 70 | 90 | | | | | |
| Septon 4033 | | | 10 | 30 | 50 | 70 | 90 |
| Puretol 10 | 235 | 235 | 235 | 235 | 235 | 235 | 235 |
| Trans Blue | 0.9 | 0.9 | 0.9 | 0.9 | 0.9 | 0.9 | 0.9 |
| Irgafos 168 | 2.75 | 2.75 | 2.75 | 2.75 | 2.75 | 2.75 | 2.75 |
| Irganox 1010 | 2.75 | 2.75 | 2.75 | 2.75 | 2.75 | 2.75 | 2.75 |

TABLE 10

| Example | Example | Example | Example | Example | Example | Example |
|---|---|---|---|---|---|---|
| 13 | 14 | 15 | 16 | 17 | 18 | 19 |

Henschel Mixing Conditions

| | | | | | | | |
|---|---|---|---|---|---|---|---|
| Mixing | Twin | Twin | Twin | Twin | Twin | Twin | Twin |
| Equipment | Screw | Screw | Screw | Screw | Screw | Screw | Screw |
| | extruder | extruder | extruder | extruder | extruder | extruder | extruder |
| Mixing | 180 | 180 | 180 | 180 | 180 | 180 | 180 |
| Temp. (° C.) | | | | | | | |
| Mixing | 500 | 500 | 500 | 500 | 500 | 500 | 500 |
| Speed (rpm) | | | | | | | |
| Order of | Altogether | Altogether | Altogether | Altogether | Altogether | Altogether | Altogether |
| Addition of | | | | | | | |
| Ingredients | | | | | | | |
| Form of Product | Pellets | Pellets | Pellets | Pellets | Pellets | Pellets | Pellets |
| After Mixing | | | | | | | |

TABLE 11

| Example | Example | Example | Example | Example | Example | Example |
|---|---|---|---|---|---|---|
| 13 | 14 | 15 | 16 | 17 | 18 | 19 |

Properties

| | | | | | | | |
|---|---|---|---|---|---|---|---|
| Shore OO Hardness | 48.3 | 51.2 | 37.3 | 44.6 | 48 | 53 | 56 |
| (ASTM D2240, 10 s delay) | | | | | | | |
| Specific gravity | 0.861 | 0.861 | 0.866 | 0.864 | 0.863 | 0.861 | 0.861 |
| (ASTM D792) | | | | | | | |
| Capillary Rheometer | 200 | 200 | 200 | 200 | 200 | 200 | 200 |
| test temperature (° C.) | | | | | | | |
| Viscosity @ | 25.5 | 26.7 | 25.2 | 19.3 | 10 | 10.8 | 9.3 |
| 1340.5/sec (Pa · s) | | | | | | | |
| Viscosity @ | 137.2 | 132.8 | 302 | 224.6 | 132.9 | 165.6 | 172.9 |
| 67/sec (Pa · s) | | | | | | | |
| Compression set test | 23 | 23 | 23 | 23 | 23 | 23 | 23 |
| temperature (° C.) | | | | | | | |
| Compression set (%) | 8.8 | 12 | 16.5 | 52.4 | 57 | 68.8 | 68.8 |
| Aesthetics of the | Good | Poor | Good | Good | Excellent | Good | Poor |
| molded plaque | | | | | | | |

The test results show that using only high styrene content SEEPS polymer or only a conventional SEEPS polymer do not result in a gel compound that exhibits the desired physical characteristics of the present technology. Conversely, compounds with a combination of high styrene content SEEPS copolymer and conventional SEEPS copolymer produce a thermoplastic elastomer with good physical characteristics.

In an embodiment, combining a high styrene content SEEPS copolymer with a medium molecular weight conventional SEEPS copolymer may provide the most desired results. In an embodiment, when the ratio is a higher high styrene content SEEPS copolymer to a conventional SEEPS copolymer amount, the resulting thermoplastic elastomer has good physical characteristics. In an embodiment, this may be any appropriate ratio, including, but not limited to, 90:10 high styrene content SEEPS copolymer:conventional SEEPS copolymer; 80:20 high styrene content SEEPS copolymer:conventional SEEPS copolymer; 70:30 high styrene content SEEPS copolymer:conventional SEEPS copolymer; 60:40 high styrene content SEEPS copolymer:conventional SEEPS copolymer; or even 50:50 high styrene content SEEPS copolymer:conventional SEEPS copolymer. When the ratio changes, the physical properties, e.g., viscosity, compression set and hardness of the gel may not change in correspondingly similar linear fashion.

The high styrene content SEEPS copolymer may not provide desired physical characteristics without a conventional SEEPS copolymer as the high styrene content SEEPS copolymer on its own has a fast setup in a melt, even if its capillary viscosity is not high. Therefore, the combination of the copolymers provides an unexpected result of a gel compound with desired physical properties, including, but not limited to, good viscosity, compression set and hardness. Further, the gel compound may be able to formed via a conventional injection molding process.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

What is claimed is:

1. A thermoplastic elastomer gel compound comprising:
(a) a high styrene content styrene-ethylene-ethylene-propylene-styrene copolymer;
(b) a conventional styrene-ethylene-ethylene-propylene-styrene copolymer; and
(c) a plasticizer;
wherein the styrene content of the high styrene content styrene-ethylene-ethylene-propylene-styrene copolymer is greater than 35% by weight of the high styrene content styrene-ethylene-ethylene-propylene-styrene copolymer and the styrene content of the conventional styrene content styrene-ethylene-ethylene-propylene-styrene copolymer is less than 35% by weight of the conventional styrene content styrene-ethylene-ethylene-propylene-styrene copolymer.

2. The compound of claim 1, wherein the ratio of high styrene content styrene-ethylene-ethylene-propylene-styrene copolymer:conventional styrene-ethylene-ethylene-propylene-styrene copolymer is about 90:10.

3. The compound of claim 1, wherein the ratio of high styrene content styrene-ethylene-ethylene-propylene-styrene copolymer:conventional styrene-ethylene-ethylene-propylene-styrene copolymer is about 80:20.

4. The compound of claim 1, wherein the ratio of high styrene content styrene-ethylene-ethylene-propylene-styrene copolymer:conventional styrene-ethylene-ethylene-propylene-styrene copolymer is about 70:30.

5. The compound of claim 1, wherein the ratio of high styrene content styrene-ethylene-ethylene-propylene-styrene copolymer:conventional styrene-ethylene-ethylene-propylene-styrene copolymer is about 60:40.

6. The compound of claim 1, wherein the ratio of high styrene content styrene-ethylene-ethylene-propylene-styrene copolymer:conventional styrene-ethylene-ethylene-propylene-styrene copolymer is about 50:50.

7. The compound of claim 1, wherein the high styrene content styrene-ethylene-ethylene-propylene-styrene copolymer is Septon™ J3341.

8. The compound of claim 1, wherein the conventional styrene-ethylene-ethylene-propylene-styrene copolymer is selected from the group consisting of Septon™ 4033; Septon™ 4044; Septon™ 4055; or combinations of two or more thereof.

9. The compound of claim 1, wherein the plasticizer oil is a mineral oil.

10. The compound of claim 1, wherein the Shore OO Hardness of the compound ranges from about 35 to about 52.

11. The compound of claim 1, wherein the compression set of the compound ranges from about 7 to about 13.

12. The compound of claim 1, wherein the viscosity @1340.5/sec of the compound ranges from about 22 to about 27.

13. The compound of claim 1, further comprising adhesion promoters; biocides; anti-fogging agents; anti-static agents; bonding, blowing and foaming agents; dispersants; fillers and extenders; fire and flame retardants and smoke suppressants; impact modifiers; initiators; lubricants; micas; pigments, colorants and dyes; additional plasticizers; processing aids; release agents; silanes, titanates and zirconates; slip and anti-blocking agents; stabilisers; stearates; ultraviolet light absorbers; viscosity regulators; waxes; and combinations of them.

14. A thermoplastic article, comprising the compound of claim 1.

15. The article of claim 14, wherein the Shore OO Hardness of the article ranges from about 35 to about 52.

16. The article of claim 14, wherein the article is injection molded.

17. A method of molding the compound of claim 1, comprising the steps of:
(a) placing the compound into a drum dispensing unit;
(b) heating the compound a bulk melter;
(c) heating the compound along a dispensing hose;
(d) heating the compound at a dispensing nozzle; and
(e) dispensing the compound into a mold.

18. The method of claim 16, wherein the heating of steps (b), (c), and (d) occur at a temperature ranging from about 120° C. to about 240° C.

19. The method of claim 17, wherein the mold is an open faced mold cavity.

20. The method of claim 17, wherein the mold is a closed mold cavity with sufficient venting to allow air to be displaced.
